(19) United States
(12) Patent Application Publication
(10) Pub. No.: US 2003/0125646 A1
(43) Pub. Date: Jul. 3, 2003

(54) Device and method for relieving pain

(76) Inventor: Russell Ward Whitlock, Las Vegas, NV (US)

Correspondence Address: Ted W. Whitlock, Registered Patent Attorney, PA, 5323 SW 38th Avenue, Ft. Lauderdale, FL, 33312, US

(21) Appl. No.: 10/331,435

(22) Filed: Dec. 30, 2002

Related U.S. Application Data
(60) Provisional application No. 60/344,711, filed on Dec. 29, 2001.

(51) Int. Cl. A61H 7/00

(52) U.S. Cl. 601/6

(57) ABSTRACT

The present invention provides a device and method for subjecting a body part to a vacuum, which can increase localized blood circulation and relieve pain. The body part is placed in contact with a hand-held hypobaric chamber in which negative pressure or vacuum is created by a vacuum pump connected thereto.

### BACKGROUND OF THE INVENTION

1. Field of the Invention

This invention relates to a device for reducing pressure and consequent pain in a body part by applying negative pressure or vacuum directly to the body part in need of treatment.

2. Description of the Prior Art

Chronic pain associated with conditions such as muscle spasms, tendonitis and sciatica is not only very painful to the individual, but is usually very difficult to treat. Inadequate treatment of chronic pain can be debilitating to humans. Conditions involving muscle spasms may result from injury or trauma to the affected muscle or nerve that innervates that muscle. Some conditions involving muscle spasms include lower back and cervical spine syndromes and whiplash injuries.

Other painful conditions include sciatica and tendonitis. Sciatica is a condition characterized by pain radiating from the muscles in the back into the buttocks. Sciatica may result from trauma to the spinal cord or to the sciatic nerve. Another condition characterized by chronic pain is tendonitis, which is inflammation of tendons and of tendon-muscle attachments.

The debilitating effects of chronic pain are not only a source of anxiety and distress for the individual, but represent a tremendous cost to society. For example, workers suffering from chronic pain are frequently absent from work for weeks or even longer. This poses a great expense to the employer in sick-time coverage, disability pay and to society in lost productivity.

Back pain is one of the most common complaints found in modern society. Known methods for alleviating pain include the use of medication which can result in great expense to the patient and may have unwanted side effects, especially in chronic use. A variety of medicinals, including muscle relaxants or even stronger drugs, have been and are currently used in an attempt to relieve pain or correct certain conditions associated with such pain. Nonsteroidal anti-inflammatory agents may also be used in conjunction with these drugs for treating muscle spasms, tendonitis and sciatica. However, these medicinals provide, at most, partial relief and do not provide relief considered adequate by most people. Accordingly, results from the use of medicinals have proven to be limited in value.

As an alternative to the use of medicinal therapies, a wide variety of devices have also been described for treatment of pain afflicting parts of the body. For example, simple devices such as heating pads or elastic compression bands, or both in combination, are commonly used to relieve back pain. Many heating devices require the thermal source to be replenished and are inconvenient to use on a regular and extended basis. The beneficial therapeutic effects from administration of heat diminish after the heat source is removed.

Many pain-relieving devices utilize positive pressure to effect a response. For example, U.S. Pat. No. 5,094,227 (Eglauf, et al.) describes a noninvasive pain relief apparatus which mechanically applies and maintains pressure to a known pressure point in order to relieve pain. The device includes a locking mechanism to lock an adjustable clamp to a selected position for applying a selected amount of pressure, and a mechanism to fine tune the amount of pressure. A release and a safety device are also provided in case the pressure exceeds a safe amount.

U.S. Pat. No. 5,336,498 (Snider) describes a method and apparatus for alleviating back pain using resiliently flexible laminated pads, with or without magnetic tape, which applies pressure to the body, particularly the back, to alleviate back pain and related symptoms due to muscle strain, tension or nerve irritation, as well as headaches and menstrual discomfort.

Devices which employ the use of negative pressure in order to provide relief of certain symptoms or conditions include, for example: U.S. Pat. No. 5,562,604 (Yablon , et al.) which describes a portable therapeutic device, and methods of use, wherein the device includes a flexible containment bag including a fluid chamber containing a fluid medium and a self-contained pumping means for causing the fluid medium to circulate and provide a therapeutic effect to a patient.

U.S. Pat. No. 5,425,742 (Joy) describes using hollow hypobaric chambers to encircle or surround body parts for increasing blood flow, reducing pressure and decreasing pain. The design of this device makes it difficult to adapt to treatment of lower back pain.

U.S. Pat. No. 5,000,164 (Cooper) discloses a circulation-enhancing apparatus comprising a boot contoured to fit a human foot, along with a modulator for providing cyclic over-pressure and vacuum pulses in synch with the heart's systolic/diastolic pulsations.

U.S. Pat. No. 4,959,047 (Tripp) discloses a flexible lower body negative pressure anti-G suit for protecting against the adverse effects of G-force acceleration.

The overall utility and success of the above-described devices has been limited, as evidenced by the millions of people that continue to suffer back pain without sufficient relief. Therefore, what is needed is a simple and convenient device which can provide pain relief by means other than the use of medication or application of positive pressure, namely, the application of negative pressure using a device which can be readily adapted for use on various parts of the body, including the lower back.

### SUMMARY OF THE INVENTION

It is an object of the present invention to provide a device for reducing pressure to a body part or localized area of the body by contacting the body part or area with a hypobaric chamber. Applying the chamber to the body part or area can increase localized blood circulation, relieve pressure, and thereby relieve or decrease pain (particularly neuropathic pain) being felt in that body part or area.

It is also an object of the invention to achieve the foregoing using a relatively inexpensive device that is simple and convenient to manufacture, as well as easy to use by an individual to carry out non-invasive self-therapy. The subject invention thus comprises an apparatus for providing negative pressure, e.g., a vacuum pump, a vacuum chamber which can be placed in, contact with a part or area of the body, and a means for connecting the chamber to the vacuum pump, such as a hose, tube, pipe or other like device so that the negative pressure created by the pump is communicated to the chamber.

The invention provides a method for reducing pressure in a particular area or body part by providing a reduced or negative pressure at the site using a portable vacuum pump and preferably, a hand-held cup-like apparatus, which forms a localized hypobaric chamber. Also, the invention preferably provides a method of increasing blood flow and decreasing pain, including neuropathic pain associated with a variety of injuries or pathologies, including sciatica or those resulting from diabetes.

Contacting a body part with the localized hypobaric chamber from which air is evacuated, particularly a hand-held chamber in the form of, e.g., a contoured cup-like apparatus, can advantageously decrease pressure on that body part or body area and thus stimulate blood circulation to and reduce pressure and consequent pain at that site. The chamber is preferably sized and shaped such that it is easily held by the user and can be placed in contact with the body part in a manner which provides a substantially air-tight seal between the contact edge of the chamber apparatus and the body part or area to which it is being applied. In a preferred embodiment, the chamber is a substantially cup-shaped apparatus which is contoured to fit snugly against a body part or area.

More preferably, the subject invention can optionally include a means for regulating the amount of pressure in the chamber by employing an adjustable valve which allows the user to regulate the amount of pressure inside the chamber relative to the outside of the chamber.

The invention can further include a sealing means disposed on the contact edge of the chamber. For example, the sealing means can be an inflatable annular ring disposed on the contact edge of the chamber which can include at least one valve for inflating or deflating the sealing means. The sealing means can also provide a cushion for the contact edge of the chamber, providing for improved comfort to the user. The inflatable seal preferably fits tightly, most preferably in an air-tight manner, against the body part being treated. The body part of a patient or user may be preferably positioned within or proximate to the chamber such that, when inflated, the inflatable seal sealingly contacts the body part.

Using the device according to the subject invention, including the embodiment wherein the inflatable seal is inflated to sealingly contact the body part, a person suffering from pain due to poor blood flow or improper tissue disposition, e.g., muscle pull, pinched nerve, slipped or ruptured disc, or the like, can place or have placed the chamber in contact with the area or body part in need of treatment. Negative pressure can then be applied to that area via pumping out air from the chamber. Hypobaric pressure is created within the chamber by the vacuum pump which is in communication with the chamber by a substantially tubular connecting means. The chamber can then be placed in contact with the body part in need of treatment. In an embodiment having a pressure regulating means, the amount of pressure can be adjusted to provide adequate negative pressure to effect the desired result, such as increased blood circulation or relief of pressure and consequent pain in the body part, but without causing discomfort or tissue damage, e.g., contusion.

For a device according to the inflatable-seal embodiment, the sealing means can be inflated to form a cushioned airtight seal around or against the body part.

The application of negative pressure to the area can reduce pressure on that area of the body, and can increase blood circulation and/or relieve pain, including neuropathic pain, at that area of the body.

### BRIEF DESCRIPTION OF THE DRAWINGS

The present invention may be more clearly understood from a reading of the following detailed description in conjunction with the accompanying drawings wherein:

FIG. 1 is a perspective view of an embodiment of the device according to the subject invention.

FIG. 2A and FIG. 2B show a perspective view of one alternative hypobaric chamber housing according to one embodiment of the invention. FIG. 2A illustrates a hypobaric chamber housing having an inflatable seal means, shown deflated, integral with the contact edge. FIG. 2B illustrates a hypobaric chamber housing having an inflatable seal means, shown inflated, integral with the contact edge.

FIG. 3A and FIG. 3B show a perspective view of another alternative hypobaric chamber housing according to one embodiment of the invention. FIG. 3A illustrates a hypobaric chamber housing configured as a contoured cup, having a handle and an inflatable seal means (shown deflated) integral with the contact edge. FIG. 3B illustrates a hypobaric chamber housing configured as a contoured cup, having an inflatable seal means (shown inflated) integral with the contact edge.

FIG. 4A and FIG. 4B show a perspective view of another alternative hypobaric chamber housing according to one embodiment of the invention. FIG. 4A illustrates a hypobaric chamber housing configured as a bell-shaped contoured cup, having an inflatable seal means (shown deflated) integral with the contact edge. FIG. 4B illustrates a hypobaric chamber housing configured as a bell-shaped contoured cup, having an inflatable seal means (shown inflated) integral with the contact edge.

FIG. 5 shows a device according to one embodiment of the subject invention in use for treatment.

### DETAILED DESCRIPTION OF THE INVENTION

A device according to the subject invention comprises a vacuum pump, a vacuum chamber bounded by a chamber housing which can be placed in contact with a part or area of the body, and preferably a means for connecting the chamber housing to the vacuum pump, e.g., a hose, tube, pipe or the like. The subject apparatus is preferably portable, and the vacuum chamber housing is configured as a hand-held device such that a user can carry out self-therapy. The invention provides an apparatus for applying localized negative pressure to a body part or area. Use of such device can increase blood flow to the body part or area and can relieve pain by reducing pressure on tissues which are injured, have been traumatized, or are misaligned in relation to one another.

The invention further provides a method for reducing pressure in a particular area or body part by providing a reduced or negative pressure at that part or area. The subject method employs the use of a portable vacuum pump and a vacuum chamber bounded by a housing, e.g., a cup-like apparatus, useful for localized pain-relief treatment. The subject method preferably comprises the steps of creating a negative air pressure by use of a vacuum pump. The vacuum pump is preferably in communication with a chamber by a connecting means which allows airflow therethrough such that negative pressure created by the vacuum pump is communicated to the chamber. This chamber formed within the chamber housing can then be placed in therapeutic proximity to a part or area of the body by placing the chamber housing in contact with the body part or area. The body part or area can benefit from application of negative pressure thereto, resulting in therapeutic relief of pain by increasing blood flow or reducing pressure at the site of placement.

Advantages of the subject invention can include, but are not limited to, low expense and ease of manufacture and use in non-invasive therapy, including self-therapy, by an individual. The subject invention can also provide effective, long-lasting treatment without chronic use of expensive or harmful medical or physical (e.g., chiropractic) therapies.

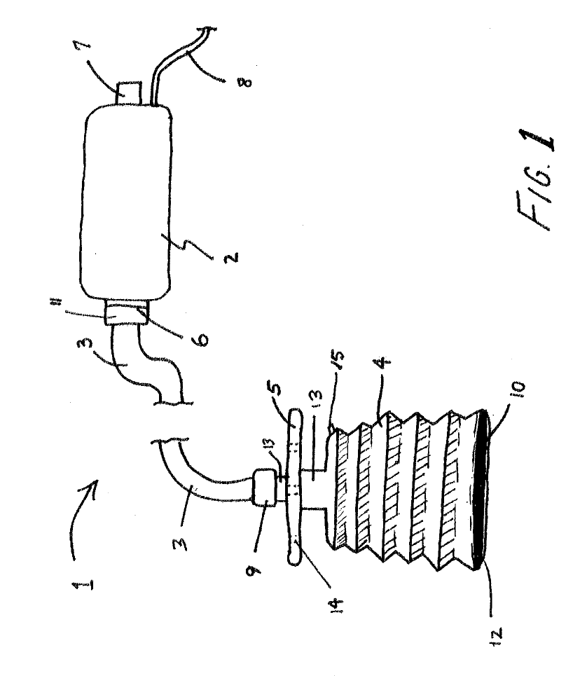

The subject invention will now be discussed in conjunction with the accompanying drawings, FIGS. 1-5.

FIG. 1 shows an embodiment of an apparatus 1 according to the subject invention comprising a vacuum pump 2 and a hypobaric chamber housing 4. Vacuum pump 2 can be any commercially available device which can be connected to, and thereby provide reduced pressure within the hypobaric chamber area bounded by hypobaric chamber housing 4. The vacuum pump can have an internal or external power source. For example, power can be supplied to the vacuum pump by an external electric source, carried by cord 8 from a wall socket (not shown). Preferably, vacuum pump 2 has an air inlet port 6 and an exhaust means, such as outlet port 7, as shown. The exhaust means can be advantageously used to inflate a sealing means as provided in certain embodiments of the device.

Air inlet port 6 connects to the hypobaric chamber housing bounding the chamber, preferably by a connecting means 3, which can be a tube, hose, pipe, or the like, so long as vacuum or negative pressure can be communicated therethrough to the chamber. A preferred connecting means has two ends and a bounding wall that is substantially rigid enough to withstand an external ambient pressure force, but which is also pliable so that it remains flexible for easily maneuvering the chamber housing into a desired position by the user. The connecting means 3 can be affixed at its one end to the vacuum pump 2 and at its other end to the hypobaric chamber housing 4 by connectors 11 and 9, respectively, e.g., a clamp or coupling means or the like which is well known in the art.

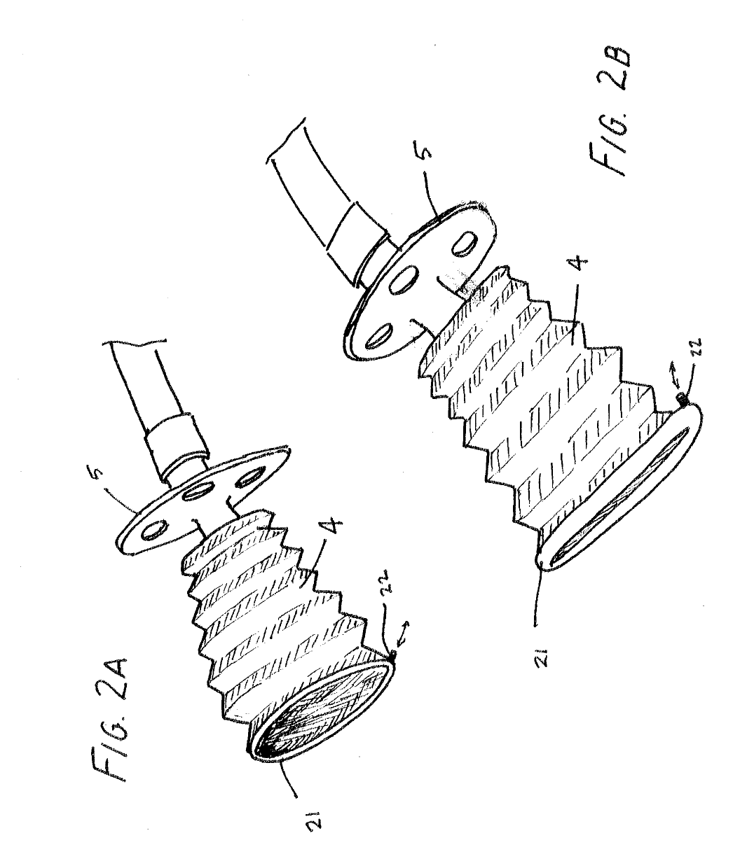

Hypobaric chamber housing 4 can be configured as a substantially bell-shaped housing wall which bounds a space and forms a chamber therewithin. In one preferred embodiment, as shown in FIG. 1, the hypobaric chamber housing is provided as being corrugated, wherein the folds or pleats are compressible and extendible in relation to one another. The material forming the housing is preferably substantially rigid enough to withstand the external ambient pressure force when vacuum is applied, but is concurrently pliable to provide flexibility and maneuverability for conforming to a particular shape of the body part or area to which it is to be applied or placed. Other configurations for the chamber housing, which are for exemplary purposes only and are not to be considered limiting in any way, are shown in FIGS. 2-4. Optionally, the hypobaric chamber housing can include an additional sealing means integral with contact edge 12, which annularly defines contact opening 10. The sealing means can be a flexible flange, cushion, inflatable cushion, or other like means to facilitate air-tight contact between the contact edge 12 and the body part or area to which it is applied during use.

Hypobaric chamber housing 4 has a second opening bounded by vacuum port 13 at the end opposite contact opening 10 whereby air can be evacuated from the chamber by the vacuum pump. Preferably, this second opening is connected to and in communication with the vacuum pump by connecting means 3, and can be affixed thereto by connector 9.

In addition, the subject device can include a handle means 5 by which the hypobaric chamber housing can be held and/or maneuvered into a desired position during use. In one embodiment, handle means 5 can comprise one or more apertures 14 (shown in phantom) extending through handle means 5. These apertures 14 can provide a convenient placement position for the fingers of the user during a therapy session.

A further optional component which the subject device can comprise is a valve 15 for releasing vacuum (allowing ambient air to enter) during or after use. The valve is preferably adjustable to permit the user to regulate the amount of negative pressure or vacuum within the chamber. During use, the valve can be partially opened so that the vacuum pull is sufficient to achieve effectiveness, but is not so great that it results in discomfort to the user or trauma to tissue. Additionally, the valve can be opened to equilibrate the pressure within and outside the chamber so that, following treatment using the device, the air-tight seal between device and the body part is broken and the device can be easily removed from the body.

In one preferred embodiment illustrated in FIG. 2A and FIG. 2B, the configuration of a corrugated hypobaric chamber housing 4 of FIG. 1 can comprise an inflatable cushion sealing means 21. The inflatable cushion sealing means 21 is shown in its deflated position in FIG. 2A and in its inflated position in FIG. 2B. The inflatable cushion sealing means 21 can be inflated or deflated at the discretion of the user by allowing air to be input or released through inflation valve 22. The inflatable cushion sealing means can advantageously facilitate contact between the device and the body part or area so that an air-tight seal is formed. Alternatively, the inflatable cushion sealing means can provide an advantage of improved comfort for the user when the housing is in contact with the body.

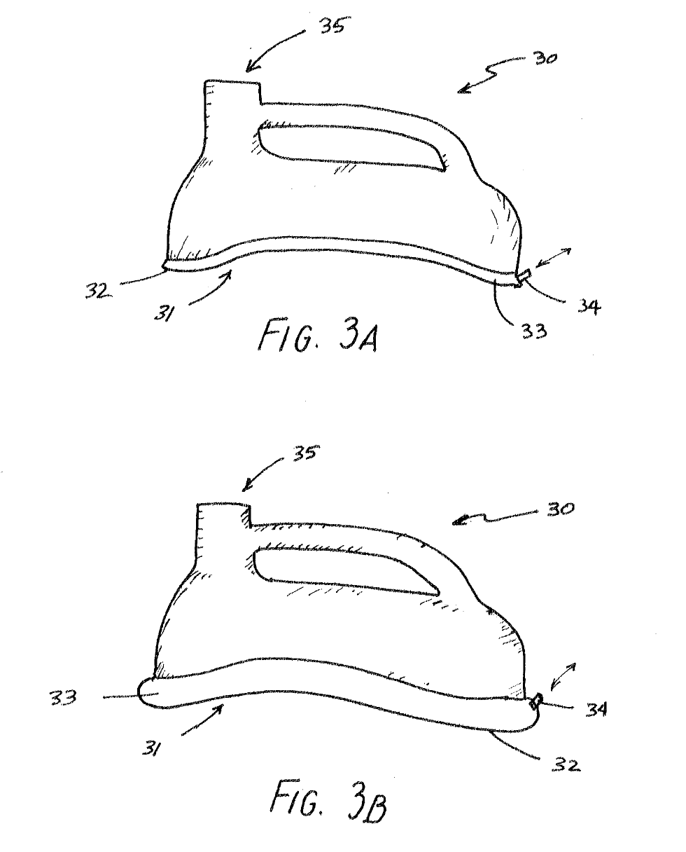

A second configuration for the hypobaric chamber housing is shown in FIG. 3A and FIG. 3B. The hypobaric chamber housing in this embodiment is made from a substantially rigid, substantially inflexible material such as a substantially rigid plastic or polymeric material. In this configuration the hypobaric chamber housing 30 has a chamber opening 31, bounded by a contact edge 32 shaped to substantially conform to the contour of the body. Vacuum port 35 communicates with the vacuum pump and can be connected thereto by a connecting means, such as a hose (not shown) as described herein. The embodiment shown includes the optional inflatable cushion sealing means 33 integral with the contact edge 32. Inflatable cushion sealing means 33 is shown deflated in FIG. 3A, and inflated in FIG. 3B. The inflatable cushion means can be inflated or deflated through inflation valve 34.

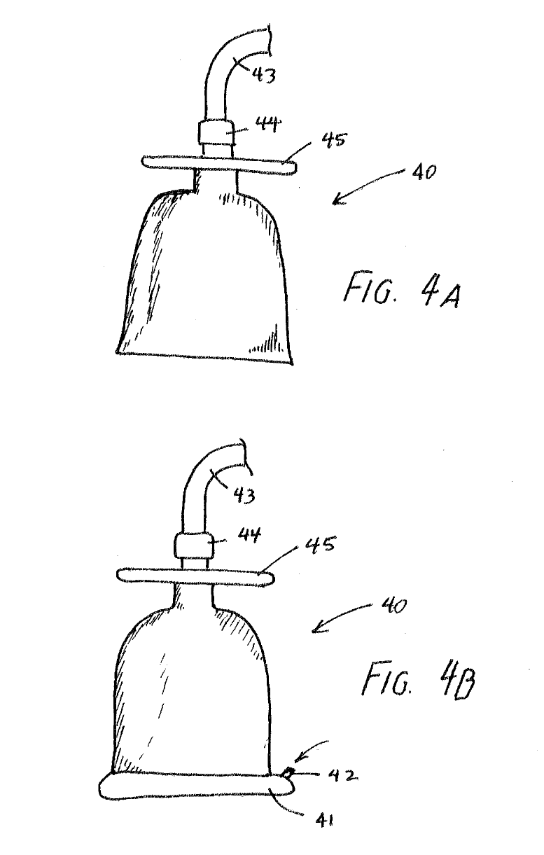

Other shapes for the substantially rigid hypobaric chamber housing can also be provided. A bell-shape configuration is exemplified in FIG. 4A and FIG. 4B. FIG. 4B shows the bell-shape configuration having an inflatable cushion sealing means 41, in its inflated position, disposed integral with contact edge 46. The inflatable cushion sealing means can be inflated or deflated through inflation valve 42. Also shown are the connecting means 43 which provides communication between the chamber and the vacuum pump (not shown). The connecting means can be affixed to the hypobaric chamber housing by connector 44. This embodiment of the device according to the subject invention device is also shown to include an optional handle means 45, which can be substantially similar to handle means 5 described for the embodiment of FIG. 1 and FIG. 2, described herein above.

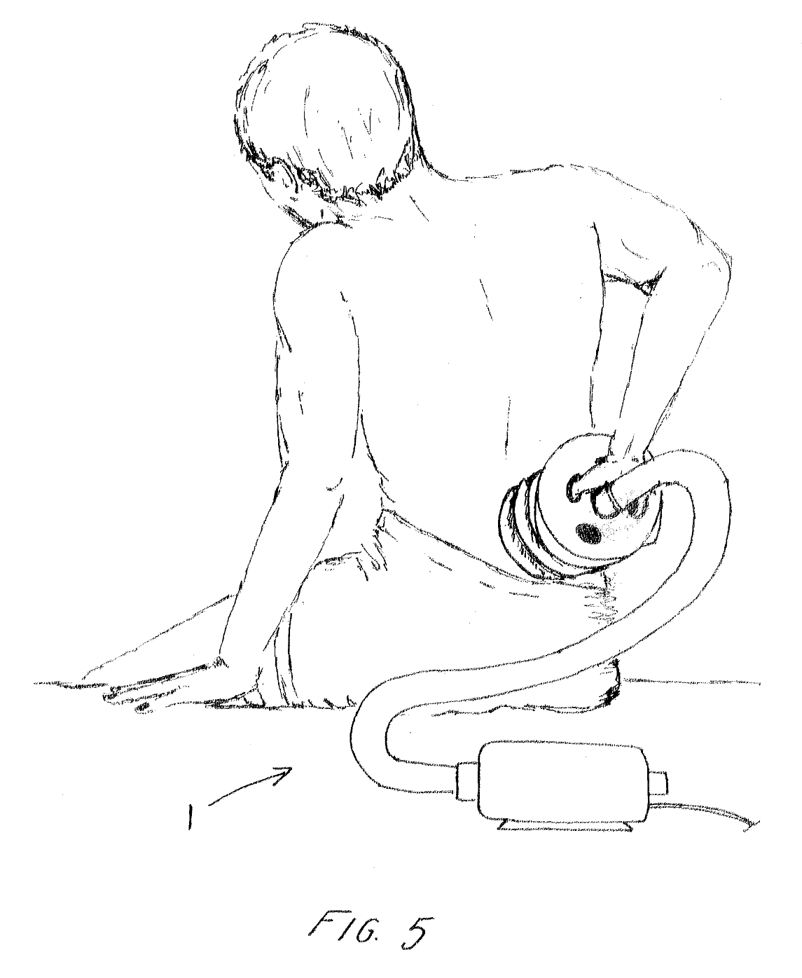

Using the device according to the subject invention, the user can place or have placed the chamber housing in contact with the area or body part in need of treatment. Use of an embodiment having an inflatable cushion sealing means can include the step of inflating the sealing means prior to placement of the chamber housing into desired position for treatment. Evacuating air from the chamber by operation of the vacuum pump thereby creates a negative pressure or vacuum within the chamber, said negative pressure being referred to the area of the body, including tissues within the body, where the chamber is positioned. In an embodiment having a pressure regulating means, the amount of pressure can be adjusted to provide adequate negative pressure to effect the desired result, such as increased blood circulation or relief of pressure and consequent pain in the body part, but without causing discomfort or tissue damage, e.g., contusion. The hypobaric chamber can be left in contact with the body for a period of time for effecting a therapeutic response. Typically, the device can be applied in contact with the body for a few minutes to a few hours, but no certain time limitations are critical, so long as relief of pain or discomfort is effected. Following a therapy session of applied negative pressure to the body part or area, operation of the vacuum pump can be stopped and the chamber housing removed from the body part or area. In an embodiment having a pressure regulation means, the vacuum within the chamber can be released or equilibrated with the pressure outside the chamber by allowing ambient air to enter the chamber prior to removal of the housing from the body part. Use of a device 1 is illustrated in FIG. 5 as being applied to the lower back for self-treatment of lower back pain.

Modifications and variations of the present invention are possible in light of the above teachings. Therefore, it is to be understood that, within the intended scope of the appended claims, modifications to the invention as described may be made, as might occur to one with skill in the field of the invention. Therefore, all embodiments contemplated have not been shown in complete detail. Other embodiments may be developed without departing from the spirit of the invention or from the scope of the claims.

1. A device for relieving pain in a body part or body area, said device comprising a vacuum pump, a hypobaric chamber bounded by a housing, and a means for connecting said pump to said chamber in vacuum communication therewith.
